(19) United States
(12) Patent Application Publication
(10) Pub. No.: US 2009/0094404 A1
(43) Pub. Date: Apr. 9, 2009

(54) Self writing storage device

(75) Inventor: Steven W. Widner, Vermillion, SD (US)

Correspondence Address: GATEWAY, INC.;ATTN: Patent Attorney, 610 GATEWAY DRIVE, MAIL DROP Y-04, N. SIOUX CITY, SD, 57049, US

(73) Assignee: Gateway Inc.

(21) Appl. No.: 11/906,720

(22) Filed: Oct. 3, 2007

(51) Int. Cl. G06F 12/00

(52) U.S. Cl. 711/100; 711/E12.001

(57) ABSTRACT

A system for a storage device to indicate that the storage device is to be overwritten to delete the data and files contained on it including remnants of previously deleted files. The system may comprise a jumper pin adapter dedicated to the purpose of overwriting the storage device. Power for the storage device can be provided by a special power adapter and the overwrite procedure can be performed as part of the storage device's power on self test so that the computer containing the storage device does not need to be booted into an operating system in order to perform the overwrite procedure.

### BACKGROUND

1. Field

The present invention relates to information handling systems, and more particularly, to systems, methods and machine readable instructions for overwriting a storage device.

2. Description of Related Art

Nearly all information handling systems, gaming devices, music and video playback systems, and many communication devices have storage memories. Computer systems typically have a hard drive which may be used to store computer programs, data and various other content accessed by the computer. Files are stored on the hard drive until the data is no longer needed and the files are deleted by a user. However, even when a file is deleted from the hard drive it remains there in some form until it has been overwritten by other data. If a person inadvertently deletes a computer file, a computer utility program may be used to recover the file, or “undelete” it, so long as the deleted file has not been overwritten by other data. Such utility programs may be used to undelete programs for nefarious purposes as well. For example, the deleted files of a discarded computer's hard drive may contain sensitive or proprietary data such as credit card numbers, personal information, or even military secrets. The sensitive data files can sometimes be undeleted by people who later find or purchase the discarded computers.

Programs and utilities are available to overwrite computer hard drives. However, it can sometimes be difficult to overwrite the hard drive of a computer, especially when the computer is being discarded. For example, as a computer gets old and begins to have maintenance problems, it may be more cost effective to simply discard the computer and purchase a new one. Similarly, if a computer is inoperative or behaving erratically due to viruses or software glitches, it may be cheaper to replace it with a new one than it would be to fix the software problems. Unfortunately it can be very difficult to overwrite the computer's hard drive if the computer is not operating properly at the time it is being discarded. Another consideration is the time and resources required to overwrite the hard drives of discarded computers. It can be very time consuming to overwrite a number of computer hard drives at once. Large companies sometimes discard all the computers for a group of people or a department at one time, for example, if a plant site is being closed or if new computers are purchased for the department. It can take a considerable amount of time for a computer technician to boot up each person's computer and run the utility to overwrite each hard disk drive. It can be especially difficult if the discarded computers are password protected at boot up.

What is needed is a more efficient system and method for overwriting data in a storage device such as a computer hard drive.

### SUMMARY

Embodiments disclosed herein address the above stated needs by providing systems and methods for overwriting the data in a computer storage device without requiring the storage device being connected to a computer with an operating system booted up and running.

In accordance with at least one embodiment for overwriting a storage device, an overwrite setting on the storage device is detected and an overwrite procedure on the storage device in response to detecting the overwrite setting. The overwrite setting may be detected during the power on self test, with the overwrite procedure being performed as part of the power on self test before the information system containing the storage device has had an operating system booted up and running.

Another embodiment provides for a storage device with a power connector for receiving electrical power to power up the storage device, a means for providing an overwrite setting, and a memory which contains the overwrite process. The means for providing the overwrite setting may be a jumper pin configuration associated with the overwrite process.

### BRIEF DESCRIPTION OF THE DRAWINGS

The accompanying drawings, which are incorporated in and constitute part of the specification, illustrate various embodiments of the invention. Together with the general description, the drawings serve to explain the principles of the invention. In the drawings:

FIG. 1A depicts exemplary information handling systems that may be used with various embodiments of the present invention;

FIG. 1B depicts a block diagram of an exemplary information handling system;

FIGS. 2A and 2B depict two exemplary types of storage devices that may be used to implement various embodiments; and

FIG. 3 is a flowchart of a method for practicing aspects of the invention.

### DETAILED DESCRIPTION

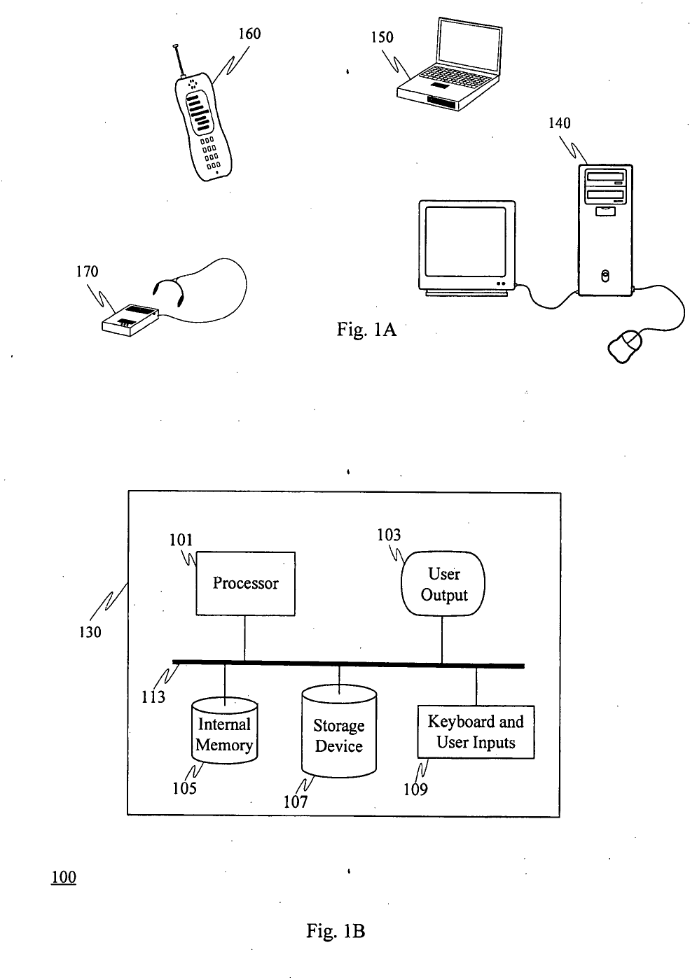

FIG. 1A depicts four exemplary information handling systems that may be used with various embodiments of the present invention. The exemplary information handling systems shown in FIG. 1A include a desktop computer system 140, a notebook (or laptop) computer 150, a wireless device 160 (e.g., a cellular telephone, a two-way pager, or other wireless device) and a media content player 170 (e.g., a MP3 player or other device for storing or playing audio or video). These four devices are included only as examples for illustrating aspects of the present invention. In practice, nearly any device that can electronically store information capable of being overwritten can be configured to implement one or more embodiments of the invention.

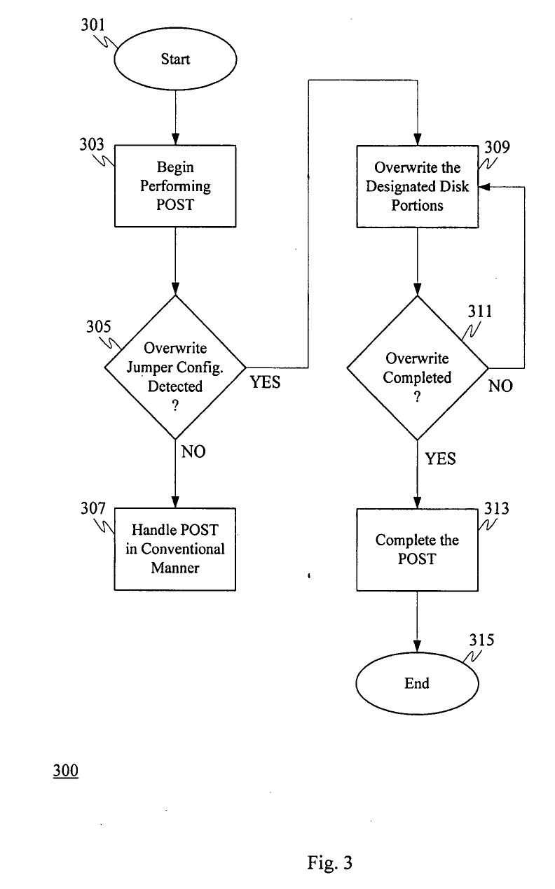

FIG. 1B depicts a block diagram 130 of an exemplary information handling system, and includes subsystems typical of an information handling system. The processor 101 may be embodied as a microprocessor, an application specific integrated circuit (ASIC), or any other circuitry or logic configured to perform or control the processes, steps and activities involved in practicing the embodiments disclosed herein, for example, the activities shown in FIG. 3. The processor 101 may be configured as a single unit or may be a combination of two or more distributed processors, or other circuitry or logic capable of carrying out commands or instructions. In various embodiments, the processor 101 may run a computer program, software, code, commands, routines or any other instructions which perform one or more of the activities depicted in FIG. 3, or otherwise discussed herein or known to those of ordinary skill in the art. In other embodiments the overwrite activities disclosed herein may be performed as part of, or in conjunction with, the POST of the storage device being overwritten before the information handling system 130 has an operating system booted up and running.

The processor 101 is communicatively coupled to internal memory 105 and storage device 107. The components of the information handling system 130 are typically interconnected via one or more buses, represented in FIG. 1 as bus 113. For example, the processor 101 is configured to communicate with internal memory 105 and storage device 107 via the bus 113 or by way of another like type of wired or wireless communication links. Although the bus 113 is depicted as a single bus connecting all of the component parts of the system, the information handling system 130 may include two or more separate buses each connected to a subset of the system components as well as being bridged together by logical circuitry.

The internal memory 105, sometimes referred to as a local memory, may be any of several types of internal storages used to store computer programs or code, including the instructions and data for carrying out activities of the various embodiments disclosed herein. The storage device 107 may be a hard disk drive of a computer system. Alternatively, the storage device 107 may be any sort of device that stores content, data or computer software of the information handling system 130 and is capable of being overwritten. The internal memory 105 and storage device 107 may be implemented in any form suitable for storing data in a computer system, for example, as random access memory (RAM), read only memory (ROM), flash memory, registers, hard disk, or removable media such as a magnetic or optical disk, or other storage medium known in the art. Either of the memories 105 and 107 may include a combination of one or more of these or other such storage devices or technologies known to those of ordinary skill in the art. The internal memory 105 and storage device 107 may each be configured to store all or parts of a computer program product which performs the various activities in forwarding an e-mail in accordance with the various embodiments.

The information handling system 130 also includes one or more input/output (I/O) units such as user display output 103 and user input devices 109. The user output display 103 may take the form of a computer monitor or screen, or any other visual output device, including, for example, a liquid crystal display (LCD) screen, a cathode ray tube (CRT) monitor, or other like type of display screen or monitor. Typically, the output 103 is configured to display a view controlled by the processor 101 running the application software of the information handling system 130. The user output 103 may include other output devices, in addition to or in place of, a display monitor, such as one or more LED indicator lights, or audio speakers, or other like type of output units. The user input devices 109 may include one or more of a keyboard, a mouse, a tablet surface and pen, a microphone and speech recognition routine, or other like types of input/output devices known to those of ordinary skill in the art. The user input devices 109 may be interfaced to bus 113 by an I/O interface (not shown) and may be connected either by cables or wirelessly to the information handling system 130. The user output 103 and user input devices 109 may include other devices known to those of ordinary skill in the art and suitable for use communicating data and commands between the information handling system 130 and a user of the device.

The information handling system 130 may be connected to the Internet and/or one or more networks such as a local area network (LAN), a wide area network (WAN), the Public Switched Telephone System (PSTN), a wireless telephone network, or the like. The information handling system 130 may be connected via such networks to another information handling system, computer, dumb terminal, or communications device configured to implement the various activities disclosed herein.

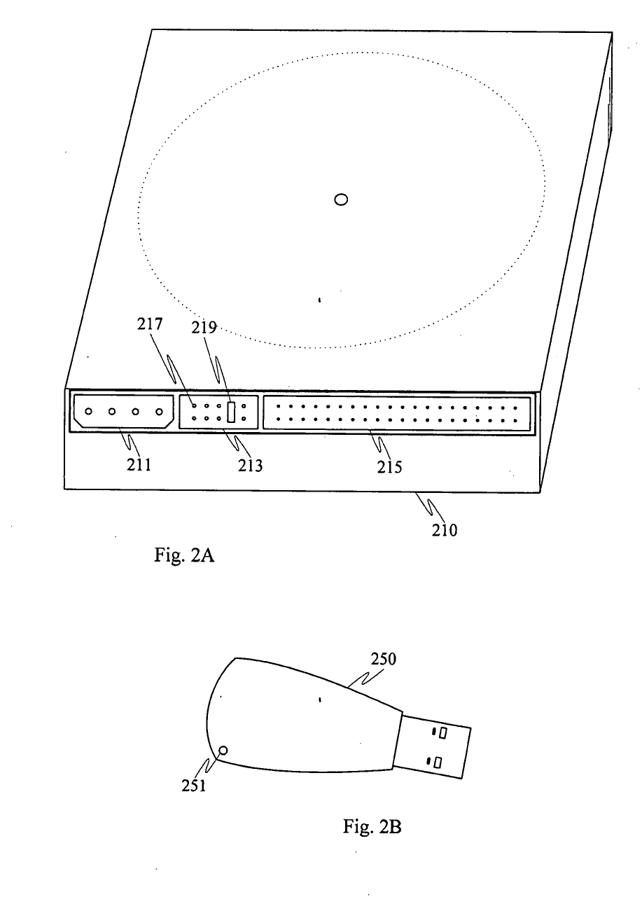

FIGS. 2A and 2B depict two exemplary types of storage devices that may be used to implement various embodiments. FIG. 2A depicts a hard drive storage device 210. Information handling systems 130—for example, the desktop computer system 140 or notebook computer 150 of FIG. 1A—typically include a hard drive storage device 210 to store computer programs, data, content, or other information in electronic form. A computer hard disk drive 210 typically has a power connector 211, a jumper block 213, and a data interface 215. The jumper block 213 is commonly used to determine where the drive is located in the storage topology. The jumper block 213 has a predetermined number of pins 217. Typically, computer jumper blocks are configured with ten pins. One or more jumpers 219 may be placed over the pins of the jumper block 213 to provide an electrical short circuit across them. Although only one jumper 219 is shown in exemplary FIG. 2A, in practice any number of jumpers may be used to provide a jumper pin configuration connecting some combination of the pins of the jumper block 213. By reading the location of jumper wires 219 attached to the jumper block 213, the drive determines whether it is configured for use as a master or slave device, or whether a feature called cable select should determine this relationship. This is typically done during power on self test (POST) of the disk drive 210. The POST of the disk drive 210 should not be confused with the computer POST, a process controlled by the computer processor. The disk drive 210 POST is controlled by the processor in the disk drive 210. The configuration indication for the disk drive 210 may be communicated to the information handling system 130 containing the disk drive 210 via the data interface 215, or to any other computer or device connected to the data interface 215.

In accordance with various embodiments, one or more jumpers 219 may be configured, or set, in a unique overwrite position on the jumper block 213. During power on self test of the drive 210 this unique overwrite position of the jumpers 219 indicates that the drive 210 (or a specified area of the drive) is to be overwritten with a predetermined data pattern. In accordance with one embodiment the jumper wires may be configured using a jumper adapter that covers all of the pins of jumper block 213 (or some of its pins), but only connects certain predetermined pins in order to provide a jumper pin configuration that indicates an overwrite setting. The jumper adapter may be designed to only fit on the jumper block 213 in the correct position, thus diminishing the possibility of incorrectly connecting the jumper pins.

In an alternative embodiment, a switch may be provided instead of using the jumper wires 219 to indicate that the drive 210 is to be overwritten. The drive 210 requires power from some source, either externally (e.g., AC plug in) or internally (e.g., battery). Power can be provided by plugging the drive's power connector 211 into an unused computer power connector or into a peripheral power adapter developed for this purpose. The peripheral power adapter may include a bank of many power connectors so that a number of disk drives can be powered up in tandem during the various stages of being overwritten, without having to wait for the completion of the overwrite cycles for each drive.

The drive 210 may be overwritten using more than one predetermined write pattern and number of write cycles. The write patterns and number of cycles can be specified in order to comply with government security requirements for secure deletion of sensitive information. The peripheral adapter may utilize the computer disk activity indicator to indicate write progress and completion, if the user decides to provide access to the data interface. Alternatively, an indicator can be added to the drive electronics and enclosure, or the device could be labeled with the appropriate over write and wait duration. Optionally, a jumper adapter may include one or more indicators for these purposes.

FIG. 2B depicts a flash memory 250 that may be used to implement various embodiments. The flash memory 250 may be a USB flash device such as a pocket drive or thumb drive. These types of flash memory devices are often not self powered and must be plugged into an information handling system for power, e.g., into the Universal Serial Bus (USB) port. A flash memory 250 may have a switch 251 for preventing the over write of data. Along with the switch 251, the flash drive 250 has a functionality of embedded device electronics to detect a switch position dedicated for the purpose of indicating that an overwrite is requested. The flash drive 250 can be inserted into an unused computer USB port or a peripheral device developed to provide power. During the device POST, if the switch is detected to be in the overwrite position the memories of the flash drive 250 are overwritten with a predetermined data pattern for a given number of cycles. This may be done to overwrite either the entire memory device, or specified portions of the device. The flash drive 250 can utilize existing LED indicators to indicate write progress and completion, or may be equipped with specialized indicators for such purposes.

FIG. 3 is a flowchart of a method 300 for practicing aspects of the invention. The method begins at 301 and proceeds to 303 to begin performing a POST. Typically, the activities for overwriting the storage device are performed as part of the POST of the storage device before the operating system has been booted up in the storage device's information handling system (e.g., before DOS or Windows has been booted the computer containing the hard drive). That is, the activities for overwriting the storage device may be performed as part of machine instructions which are part of the power on self test (POST), or performed in conjunction with the POST, before the operating system of the computer containing the storage device has been booted up. However, in some embodiments the overwriting process may be performed with an operating system booted in the computer, upon detecting an overwrite setting of the storage device. Once the POST has been begun in 303 the method proceeds to 305.

In 305 it is determined whether an overwrite setting has been detected during the POST of the storage device. The overwrite setting may be a predefined unique configuration of jumper wires on the jumper block of the storage device. Alternatively, the overwrite setting may be a setting for an overwrite switch of the storage device. If no overwrite setting is detected in 305 the method proceeds to 307 along the “NO” branch and the POST continues in the conventional manner as the device is booted up. However, if an overwrite setting is detected in 305 the method proceeds from 305 along the “YES” branch to 309. Optionally, a user prompt may be displayed that inquires whether the overwrite operation should proceed, and the overwrite operation may commence only upon an affirmative response from the user.

In 309 the storage device is overwritten in response to detecting the overwrite setting, for example, during the POST of the storage device. In accordance with some embodiments, there may be different overwrite settings to indicate the manner in which the overwrite procedure is to be carried out. For example, there may be a unique overwrite setting to specify that the entire storage device is to be overwritten, while a different unique overwrite setting specifies that only the empty portions of the storage device (containing deleted files) are to be overwritten. In accordance with another aspect, the details for performing the overwrite procedure may be specified by the particular unique overwrite setting. For example, one overwrite setting may indicate that the overwrite procedure conform to given requirements set forth by a governmental agency, e.g., a Department of Defense (DoD) agency. The overwrite setting may also indicate the number of cycles (times the device is to be overwritten) and the pattern to be used in overwriting the storage device. In some embodiments there may be only a single overwrite setting for the storage device, and the specifics of the overwrite procedure are determined by particular overwrite instructions contained in the storage device. Once the overwrite process have begun in 309 the method proceeds to 311.

In 311 it is determined whether the overwrite procedure has been completed. The storage device may utilize an existing indicator such as a light emitting diode (LED) to indicate the write progress and completion. For example, an LED of the storage device can be controlled to blink on and off at a certain rate while the overwrite procedure is being performed, and then go off (or blink in a different manner) when the procedure is finished. In this way the person (or machine) overseeing the overwrite procedure can know when it has been completed. Alternatively, the storage device can be monitored to determine whether the read/write processes are actively taking place, for example, by detecting whether the disks are spinning and/or read/write heads are moving. If it is determined in 311 that the overwrite procedure is still under way the method proceeds from 311 along the “NO” path back to 309. However, if it is determined in 311 that the overwrite procedure has been completed the method proceeds from 311 along the “YES” path to 313.

In 313 the storage device returns to completing the POST of the storage device since the overwrite procedure has been completed. In some embodiments the POST of the storage device may end upon completing the overwrite procedure, since the storage device's contents have been erased. Upon completing 313 the method proceeds to 315 and ends.

Various activities may be included or excluded as described above, or performed in a different order, with the rest of the activities still remaining within the scope of at least one exemplary embodiment. For example, block 313 may be omitted so that once the overwrite procedure has been completed the POST for the storage device simply ends. In such an embodiment the flowchart of FIG. 3 would have 311 proceeding directly to the end at 315 rather than to 313. Other variations to the embodiments are within the scope of this disclosure, as would be known by those of ordinary skill in the art.

The invention may be implemented with any sort of processing units, processors and controllers (e.g., similar to processor 101 of FIG. 1B) capable of performing the stated functions and activities. A processing unit in accordance with at least one exemplary embodiment can operate computer software programs stored (embodied) on computer-readable medium such as a. hard disk, CD, flash memory, RAM, firmware, or other computer readable medium as recognized by one of ordinary skill in the art. The overwrite procedure for performing the steps and activities described above can be a part of the POST of the storage device. That is, machine instructions may be provided as part of the POST for carrying out the various steps and activities of the overwriting procedure. Alternatively, computer software, instructions or other code for performing the steps and activities can be stored elsewhere on the storage device, for example in the form of firmware, and may be accessible during the POST.

The use of the word “exemplary” in this disclosure is intended to mean that the embodiment or element so described serves as an example, instance, or illustration, and is not necessarily to be construed as preferred or advantageous over other embodiments or elements. The description of the various exemplary embodiments provided above is illustrative in nature and is not intended to limit the invention, its application, or uses. Thus, variations that do not depart from the gist of the invention are intended to be within the scope of the embodiments of the present invention. Such variations are not to be regarded as a departure from the spirit and scope of the present invention.

What is claimed is:

1. A method of overwriting a storage device, the method comprising:
detecting an overwrite setting on the storage device, the overwrite setting being associated with an overwrite procedure; and
performing the overwrite procedure on the storage device in response to detecting the overwrite setting.

2. The method of claim 1, further comprising providing a jumper adapter configured to removably engage jumper pins on the storage device in a manner signaling the overwrite setting to the storage device.

3. The method of claim 1, further comprising:
performing a power on self test for the storage device;
wherein the overwrite setting is detected during the power on self test.

4. The method of claim 3, wherein the power on self test is performed before booting an operating system.

5. The method of claim 1, wherein the overwrite setting is a jumper configuration on pins of a jumper block of the storage device.

6. The method of claim 1, wherein the storage device is a hard disk drive, the method further comprising:
providing power to the storage device from a power source.

7. The method of claim 6, wherein the power source is a peripheral power adapter configured to connect to a power connector of the storage device.

8. The method of claim 1, further comprising:
displaying a user prompt inquiring whether to proceed with the overwrite procedure.

9. The method of claim 1, wherein the overwrite procedure overwrites the entire storage device.

10. The method of claim 1, wherein the overwrite procedure conforms to requirements set forth by a governmental agency.

11. A method of overwriting a storage device, the method comprising:
providing an overwrite setting on the storage device, the overwrite setting being associated with an overwrite procedure; and
applying power to the storage device;
wherein the overwrite procedure is performed on the storage device in response to detecting the overwrite setting.

12. The method of claim 11, wherein the overwrite setting is detected during a power on self test of the storage device.

13. The method of claim 12, wherein the power on self test is performed before booting an operating system.

14. The method of claim 11, wherein the storage device is a hard disk drive.

15. Firmware comprising an electronically readable medium including machine readable instructions, wherein the instructions upon being executed cause a storage device to:
detect an overwrite setting on the storage device, the overwrite setting being associated with an overwrite procedure; and
perform the overwrite procedure on the storage device in response to detecting the overwrite setting.

16. The firmware of claim 15, wherein the instructions are part of a power on self test of the storage device; and
wherein the overwrite setting is detected during the power on self test.

17. A storage device comprising:
a power connector configured to receive electrical power for powering up the storage device;
means for providing an overwrite setting; and
memory configured to store an overwrite process performed in response to detecting the overwrite setting.

18. The storage device of claim 17, wherein said means for providing the overwrite setting is a jumper pin configuration associated with the overwrite process.

19. The storage device of claim 17, wherein the detecting of the overwrite setting is performed as part of a power on self test for the storage device.

20. The storage device of claim 17, wherein the means for providing an overwrite setting includes jumper pins and a jumper adapter removably engagable with the jumper pins such that engagement of the jumper adapter with the jumper pins signals an overwrite setting.
